(19) United States
(12) Patent Application Publication
(10) Pub. No.: US 2011/0268840 A1
(43) Pub. Date: Nov. 3, 2011

(54) Production of Bagels

(75) Inventors: John Edward McDonnell, Ramsey, NJ (US); Barry W. Slobodow, Warren, NJ (US)

(73) Assignee: OROGRAIN BAKERIES PRODUCTS, INC., Horsham, PA (US)

(21) Appl. No.: 12/770,567

(22) Filed: Apr. 29, 2010

(51) Int. Cl. A21D 8/04; A21B 5/00; A23P 1/00; A21D 13/00

(52) U.S. Cl. 426/19; 426/551; 99/354; 99/450.2

(57) ABSTRACT

An improved bagel dough product and method for processing the bagel dough product into a finished bagel product, including thin bagel products. Mixed bagel dough is sheeted, the bagel dough including, per 100 parts of total weight: between 45-60 parts hard wheat flour and between 25-40 parts water. The bagel dough is flattened into a sheet with a thickness between about 0.2 and 0.8 inches. The flattened bagel dough sheet is fed to a cutter-picker assembly that includes an automated cutter and an automated hole removal tool. The bagel dough sheet is cut into a plurality of substantially toroidal-shaped bagel dough pieces using the automated cutter, each toroidal-shaped bagel dough piece including a ring piece and a hole piece. The bagel hole pieces are removed using the automated hole remover tool, and the ring pieces are further processed by fermenting, water cooking, and baking the ring pieces.

### TECHNICAL FIELD

This document relates to baked food products, and more particularly a bagel using cutter-picker machinery.

### BACKGROUND

Bagels are popular baked goods, formed into a ring from yeasted wheat dough. A hole typically occupies the geometric center of the bagel, giving bagels a unique, easily-identifiable shape. Aside from its cosmetic value, the bagel hole allows for more even and thorough cooking and baking of the dough. Traditionally, bagels are boiled or steamed in water before they are baked, reducing the starch content and creating bagels' characteristically chewy crust. Traditional bagel recipes are also known as a healthy substitute for other yeast-based breads, including bagels' deep-fried, toroidal cousin, the doughnut. For instance, the traditional water bagel is made without fat (such as shortening, oil, or butter) or eggs, and consequently is chewier than other breads. Bagels come in dozens of varieties, from sweet to savory, and may contain dried fruit, nuts, seeds, herbs, spices, or sweeteners. They are available in whole-wheat, white, and multi-grain varieties.

As demand for bagels has increased, commercial bakeries have developed machines and automated processes for making and mass-producing bagels. Typical bagel production involves dividing and subdividing large masses of bagel dough into chunks of dough that can then be formed into bagels. The chunks of dough can be cut so as to meet a desired weight, in an attempt to make bagels of uniform size and mass. Machines can be used to uniformly divide the dough into equal lumps using apparatus such as pistons, blades, or extruders. The dividing apparatus may be fed manually or by a dough hopper. Once the dough has been divided, each chunk of bagel dough is formed by rounding or rolling the chunk, either by hand or machine, into an elongate dough chunk. The telltale bagel hole can then be formed, for example, by bending the chunk so that two ends of the chunk meet end to end to form a circle (or, more precisely, a toroid). Additional automation can be employed to process the formed pre-cooked bagels, for instance, by automating removal of the dough pieces or automatically feeding the dough into the next process of a production line.

Unlike bagels, doughnuts are not known for their low- to non-fat content or chewy texture and crust. Doughnuts can be yeast-based, as well as cake-based and are known to have a much lighter texture and higher fat content than bagels. Further, doughnuts typically have a crisp or cake-like crust. Rather than boiling and baking, doughnuts are deep-fried. Automated machinery have also been developed for doughnut production and frying, including proofing, forming, and frosting doughnuts. In some instances, yeast-based doughnuts are prepared by rolling a sheet of yeast-based doughnut dough, cutting doughnut-shaped dough pieces from the doughnut dough sheet, and deep-frying the doughnut dough pieces using an automated process. Such a process has been considered appropriate for doughnut production because doughnut dough exhibits comparably low elasticity and viscosity, permitting doughnut dough to be easily rolled and sheeted.

Bagels are characterized as much by their unique consistency—a chewy crust and spongy interior—as their low fat content. To achieve these characteristics, a very turgid, high-protein-flour-based dough, with relatively high viscosity, elasticity, and dough memory, is typically used in conventional bagels. Dough memory references the characteristic tendency of a dough to resist stretching, rolling, or flattening. Dough high in viscosity or elasticity tends to have a higher dough memory and are more difficult to process into a desired form. Consequently, the generally viscous and elastic nature of bagel dough has limited the scope of processes and machines suitable for mass-production of bagels. For example, most modern bagel producers employ machines and processes that employ a divide and form process, where a large mass of bagel dough is cut, or divided, into lumps of dough corresponding to the mass and size desired for a single bagel. With the dough cut to the approximate desired dimensions, subsequent processing of the dough can be directed to making relatively minor adjustments to the dough's shape, such as rounding the dough lump's edges and introducing a hole into the dough lump's center to form a toroidal bagel shape. While divide and form processes are well-suited to dealing with high-memory bagel dough, such processes generally suffer from inconsistent weight control and result in the production of non-uniform bagel products.

### SUMMARY

Disclosed is an improved method for processing a bagel dough product into a finished bagel product, including thin bagel products. Mixed bagel dough is sheeted, using dough sheeting equipment, the bagel dough including, per 100 parts of total weight: between 45 and 60 parts hard wheat flour, wherein hard wheat flour is at least 11% protein by weight, and between 25 and 45 parts water. The bagel dough is flattened, using at least one roller, into a sheet with a thickness between about 0.2 and 0.8 inches. The flattened bagel dough sheet is fed to a cutter-picker assembly that includes an automated cutter and an automated hole removal tool. The bagel dough sheet is then cut into a plurality of substantially toroidal-shaped bagel dough pieces using the automated cutter, each toroidal-shaped bagel dough piece including a ring piece and a hole piece. The bagel hole pieces are removed from each of the plurality of toroidal-shaped bagel dough pieces with the automated hole remover tool, and the ring pieces are further processed by fermenting, water cooking, and baking the ring pieces.

In some aspects, the ring pieces can be fermented in a proofer, cooked in water, and baked in an oven. Cooking the bagel dough pieces can include steaming the bagel dough piece. The bagel dough can be flattened into a sheet with a substantially uniform thickness between 0.2 inches and 0.4 inches to produce a finished bagel with a thickness between 0.4 and 1.0 inches and a substantially ovular toroidal surface of rotation. The bagel dough can further include, per 100 parts of total weight, between 45 and 55 parts hard wheat flour, between 35 and 40 parts water, and between 4 and 8 parts fiber. In some instances, the bagel dough can also include, per 100 parts of total weight, at least 1.5 parts gluten. The bagel dough can be flattened into a sheet with a uniform thickness between 0.5 inches and 0.8 inches to produce a finished bagel with a thickness greater than 1.5 inches. Uncooked bagel dough pieces can also be topped with a topping ingredient.

In some aspects, cutting the bagel dough sheet can include using an automated cutter having a plurality of die cutters, each die adapted to cut the bagel dough sheet into substantially toroidal-shaped bagel dough pieces. A cutter can be used that is one of a rotary die cutter or flat bed die cutter. The plurality of die cutters can each include an outer blade cup and an inner blade cup, the inner blade cup positioned within and coaxial with the outer blade cup, wherein at least one of the outer blade cup and inner blade cup has an ovular shape. An ovular shaped blade cup can be configured to produce a bagel dough piece that, after subsequent transportation, cooking, and baking, produces a substantially circular finished bagel. The automated bagel hole remover can include a plurality of picks mounted on a rotary axle, each pick adapted to spear a hole piece and separate it from a corresponding ring piece according to a timed interval, and a paddle adapted to contact the hole piece on at least one corresponding pick of the plurality of picks and remove the contacted hole piece from the at least one corresponding pick and divert the hole piece away from the ring piece.

In another general aspect, a bagel dough food product, adapted for sheeting on a bagel production assembly to produce a bagel dough sheet with uniform thickness between 0.2 and 0.4 inches, can include, per 100 parts of total weight, between 40 and 55 parts hard wheat flour, wherein hard wheat flour is at least 11% protein by weight, between 35 and 45 parts water, between 1 and 3 parts yeast, between 1 and 3 parts gluten, and between 4 and 8 parts fiber.

In certain aspects, hard wheat flour can have at least 13.5% protein by weight. In additional aspects, the bagel dough food product can have substantially no fat content. The bagel dough food product, when formed into a toroidal, bagel shape, cooked in water, and baked, can form a bagel. The bagel dough product can be processed to produce a finished bagel by cutting a plurality of toroidal shaped bagel dough pieces from the sheet using an automated cutter having a plurality of dies to form a plurality of bagel dough ring pieces and bagel dough hole pieces, removing the hole pieces using an automated hole removal picker, fermenting the ring pieces in a proofer, water cooking the fermented ring pieces, and baking the water cooked ring pieces in an oven. Water cooking the fermented ring pieces can include steaming the fermented ring pieces. A finished bagel food product can be substantially toroidal and have a two-dimensional cross-section surface of rotation with a width (x) between 1.6 and 3.2 times the thickness (y) of the cross-section surface. A finished bagel food product can have an outer diameter between 4.0 and 4.5 inches, a hole with a diameter between 0.75 and 1.0 inches, and a thickness (y) between 0.6 and 0.9 inches.

In another general aspect, a bagel production apparatus can include a sheeting table to which a bagel dough is supplied, at least one roller adapted to flatten the dough to a dough sheet having a thickness between about 0.2 and 0.8 inches, an automated cutter plate adapted to cut the bagel dough sheet into a plurality of substantially toroidal-shaped bagel dough pieces using the cutter, each toroidal-shaped bagel dough piece including a ring piece and a hole piece, an automated hole picker device, adapted to remove the hole piece from the ring piece, a bagel dough proofer, a water cooking apparatus for partially cooking proofed ring dough pieces, and an oven for baking partially-cooked ring dough pieces.

In some aspects, a cutter plate can be a rotary die cutter including a plurality of dies, each die adapted to cut toroidal-shaped bagel dough pieces from the dough sheet. A hole picker device can include a plurality of picks, each pick adapted to spear and remove bagel hole dough pieces from the ring dough piece, wherein the plurality of picks are attached to a rotating axle timed to cause the end of at least one of the picks to spear a hole dough piece as the hole dough piece is conveyed on a sheeting table, and a plurality of paddles, each paddle adapted to contact at least one of the hole pieces on at least one of the picks and remove the speared hole dough piece from the pick. The water-cooking apparatus can include a steamer or a boiler.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example of a bagel production assembly.

FIG. 2A is a perspective view of an example implementation of a rotary cutter capable of being used in a bagel production assembly.

FIG. 2B is a front view of the example rotary cutter of FIG. 2A.

FIG. 3A is top view of an example of a single die cutter of the rotary cutter of FIGS. 2A and 2B.

FIG. 3B is a side view of the example die cutter of FIG. 3B.

FIG. 4A is a first view of a rotary picker tool in operation in a picker assembly.

FIG. 4B is a second view of a rotary picker tool in operation in a picker assembly.

FIG. 4C is a third view of a rotary picker tool in operation in a picker assembly.

FIG. 5 is a view of a specialized sheeting table used to separate bagel ring dough pieces from a sheet of cut bagel dough.

FIG. 6A is a cross-sectional view of a traditional bagel.

FIG. 6B is a cross-sectional view of a thin bagel made using an improved bagel dough recipe.

Like reference symbols in the various drawings indicate like elements.

### DETAILED DESCRIPTION OF ILLUSTRATIVE EMBODIMENTS

An improved bagel production process can be used that results in higher efficiency output and more uniform weight control than in traditional divide and form processes. Bagel dough can be rolled and sheeted to a uniform thickness and then cut into a toroidal shape using a stamp or rotary cutter. An improved dough composition can also be used, adapted for rolling and sheeting in a mass-production process, that exhibits lower dough memory while still providing a bagel with the characteristic chewy, spongy consistency and low fat content. Moreover, by employing a bagel-making process with a rolling and sheeting step, the thickness of bagels can be controlled, allowing for the production of bagels thinner than traditional bagels. By way of example, thin bagels can be desirable for use in sandwiches, where the consumer desires a lower bagel-to-sandwich-topping ratio, or for consumers eager to enjoy a lower calorie, or lower carbohydrate bagel variety.

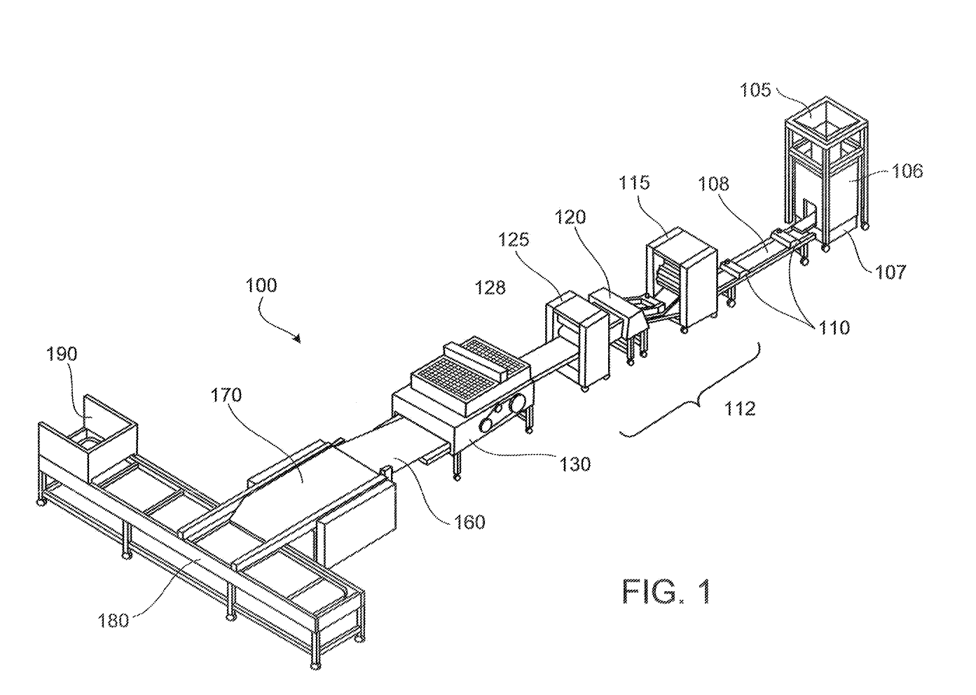

FIG. 1 illustrates an example production line assembly 100 employing an improved bagel production technique. In one embodiment, mixed bagel dough may be delivered from a mixer via a manual dough trough feeder (not shown) to a dough hopper 105 (dough reservoir/preportioner), descending then into a chunker 106. In this example, the chunker 106 cuts, and thereby reduces, the large dough deposit into more manageable portions (in this example 30 to 45 pound portions) and feeds the dough portions to a vertical laminator 107 located below the chunker 106. The vertical laminator 107 can feed a continuous flow of dough sheet pieces. Alternatively, dough can be continuously extruded, for example in a form of a thick continuous sheet from an extruder. The dough sheet can then be delivered to a sheeting table 108 conveyor through a pair of reduction rollers (not shown). The reduction rollers and sheeting conveyor may-move the dough sheet past two flour dusters 110 arranged in series that add flour to the conveyor surface and a top surface of the dough sheet in order to prevent sticking leading into a roller assembly 112. A roller assembly 112 can include one or more rollers 115, 120, 125. In the example embodiment illustrated in FIG. 1, roller assembly 112 includes a plurality of rollers, for example a satellite roller assembly 115, a cross roller 120, and a gauging roller station 125 arranged in series to produce a sheet of unproofed dough that is between about 12 inches to 48 inches wide, preferably between about 18 inches to 32 inches wide, for example about 24.5 inches to 26 inches wide, and about 0.2 inches to about 0.8 inches thick. To achieve a thin bagel, with a finished thickness between 0.5 inches and 1.0 inches, the sheet of unproofed dough should be rolled to a thickness of between 0.2 inches and 0.4 inches. To achieve a bagel with a more typical thickness, with a finished depth between 1.25 and 2.0 inches, the unproofed dough should be rolled typically between about 0.4 inches to 0.6 inches thick, for example about 0.45 inches to 0.55 inches thick. The satellite roller 115 and the cross roller 120 reduce the dough sheet thickness and advantageously spreads the dough until the desired width is attained. A flour duster 110 may be added between the satellite roller 115 and cross roller 120 to apply flour to the top of the dough sheet and mitigate sticking. Finally, advantageously a gauging roller station 125 reduces the dough sheet to its final thickness. Once the dough is rolled to a sheet of uniform and desired thickness, the bagel dough sheet can be fed, on a sheeting table 128 conveyor, from the roller assembly 112 to a cutter-picker assembly 130. The cutter-picker assembly 130 cuts the dough sheet, through the use of die cutters. A die can be made of one or more knife-edged cutting blades formed into a particular pattern. In this instance, cutter-picker dies are shaped like concentric circles to cut a plurality of toroidal-shaped dough pieces from the dough sheet. The outer concentric circle cut by the die corresponds to the outer circumference of the bagel, the inner concentric circle corresponds to the bagel hole. Upon being cut by the die, the toroidal-shaped dough piece includes an outer ring piece, corresponding to the bagel, and an inner “hole” piece, corresponding to the bagel hole. In some implementations, the die can be adapted to cut entirely through the dough sheet. A rubber anvil or other backer can be used to assist in achieving a clean cut, through the dough sheet. In other implementations, the dies may be adapted to cut through only a portion of the dough. For instance, the die may be adapted to cut only part way through the dough sheet at one or more points along the die. This can serve to leave a membrane of dough connecting at least the ring piece to the remaining dough sheet or the hole piece to the ring piece to assist, for example, in preventing the ring piece and/or hole piece from being prematurely separated and removed during processing. In one example, a notch can be cut in the die to leave a thin strand of dough connecting the ring piece to the hole piece and/or remaining dough sheet. In some instances, the cut pieces should only be removed at particular steps in the assembly line, for instance, at a picking step. Indeed, in the particular example illustrated in FIG. 1, the cut pieces proceed to a “picking” mechanism of the cutter-picker adapted to remove and relocate the corresponding, central “hole” dough pieces.

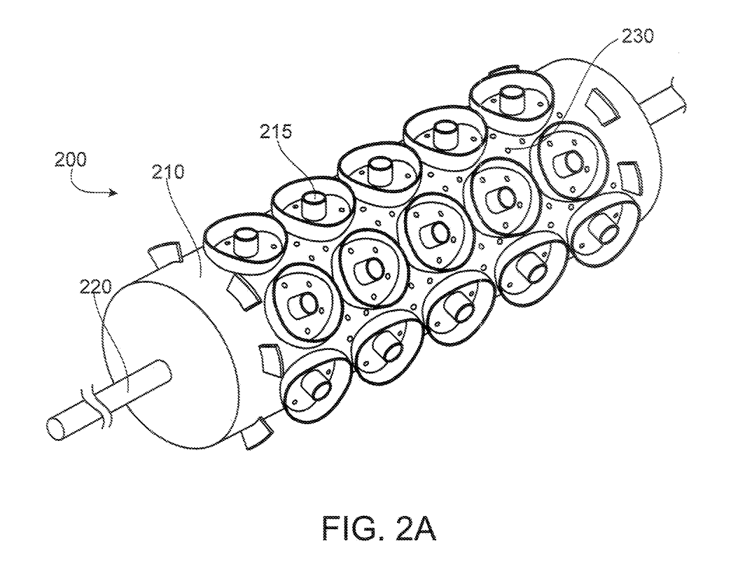

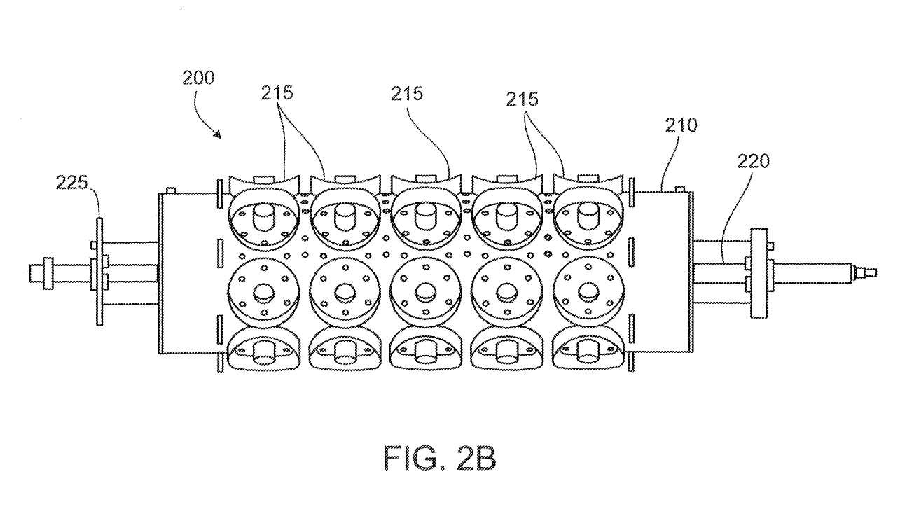

The cutter portion of the cutter-picker assembly can be, for example, a flat bed die cutter, or other stamp die cutter, or rotary die cutter. FIGS. 2A and 2B are illustrative views of an example implementation of a rotary cutter 200 adapted to cut a sheet of rolled dough into a plurality of toroidal-shaped dough pieces. A perspective view (FIG. 2A) and front view (FIG. 2B) of rotary cutter 200 show a 30.0 inch wide rotary cutter tube 210 having seven rows of five dies 215 adapted to cut a dough sheet into rows of toroidal-shaped dough pieces. Consequently, in this example, the rotary cutter is capable of cutting up to 35 bagel-shaped dough pieces per revolution. The tube 210 and dies 215 are adapted to revolve around an axle 220 when driven by a motor or other driving device. In the illustrated example, the cutter tube 210 is driven through a sprocket 225 mounted on the cutter axle 220. In other examples, a cutter tube with a larger circumference and/or width can be used to add additional dies to each row of dies or to add additional die rows. In alternative examples, a stamp cutter can be employed in lieu of a rotary cutter, with a plurality of dies coupled thereto, to cut a plurality of bagel-shaped dough pieces from the dough sheet. As shown in the example illustrated in FIGS. 2A and 2B, in some implementations, the cutter can be provided with mechanisms that assist in cleanly cutting, what can be sticky and viscous bagel dough. For instance, air can be fed out of the cutter tube 210 through a plurality of apertures 230. The air can serve to push against the dough sheet during cutting to discourage dough from sticking to the outer surface tube 210 or dies 215 as the cutter comes in contact with the dough sheet. In some instances, the dough, upon being cut by the die, can tend to stick to and be prematurely removed by the die, which can then lead to the deformation of subsequent bagel dough pieces processed by the die. Air pushed through the dies, toward the dough sheet, can push the cut pieces from the die surface preventing the cut pieces from sticking to the die.

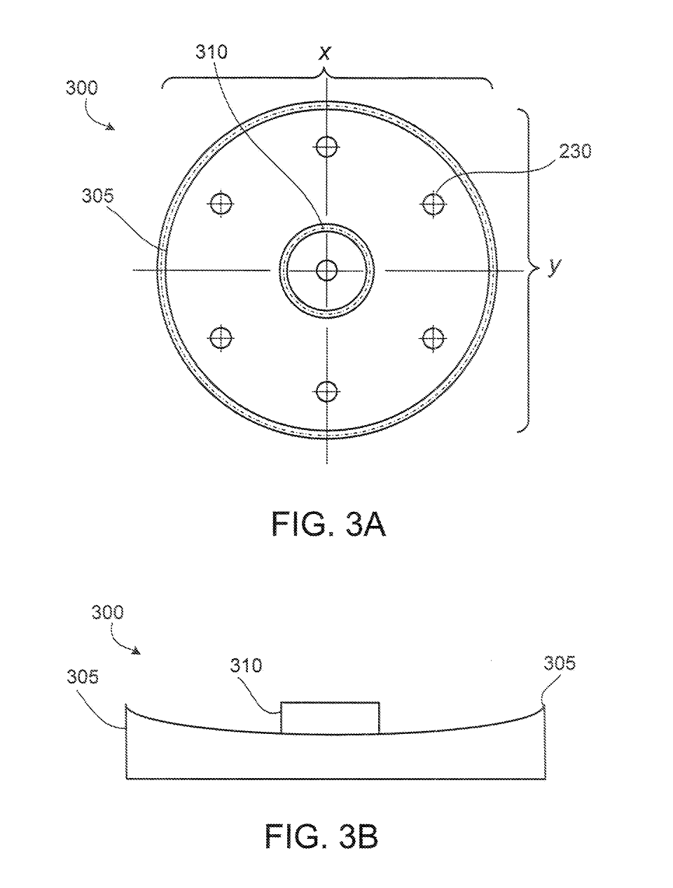

FIGS. 3A and 3B illustrate top and side views, respectively, of one example of a single die 300 used in the cutter of a cutter-die assembly. In this particular example, the dimensions of the dies are slightly oblong, or ovular. In some implementations, in order to achieve as near to a perfectly round, finished bagel product, it may be necessary to bias the dimensions of the cut bagel dough in light of subsequent transport and processing steps that may affect the shape or dimensions of the cut dough pieces. For instance, in some implementations, the force of conveyor belts used to transport cut dough pieces from the cutter-picker may contract the cut dough pieces along a dimension parallel to the direction of the dough piece's travel along the belt. In such an instance, it may be desirable to cut the dough so that the resulting bagel dough piece is wider (or oblong) in the dimension where contraction is expected, so as to compensate for contracting forces acting on the dough during the remaining process steps so that a substantially circular finished product is realized. Accordingly, dies may be provided that are correspondingly oblong in dimension. For instance, as shown in the example of FIG. 3A, the die 300 used to cut bagel-shaped dough pieces from the dough sheet entering the cutter-picker, may have a first blade 305, corresponding to the outer circumference of the bagel, with a first dimension (x) longer than a second, orthogonal dimension (y). In this particular example, the die is 4.25 inches in dimension x and 3.875 inches in dimension y. In the example of FIG. 3A, the blade 310 corresponding to the cutting of the bagel hole, is substantially circular. In other examples, however, the dimensions of the bagel hole blade 310 can also be adjusted, or biased, based on process steps subsequent to cutting, in order to realize a uniform or circular bagel hole.

In FIG. 3B, a side view of the single cutter die 300 of FIG. 3A is shown. In this particular example, the outer blade, or cup 305, is not uniform in depth, but has a curved lip 315 to assist in cleanly initiating and exiting a cut of the dough sheet. The curve in the lip 315 can be adapted, for instance to compensate for dough shrinkage in the direction of travel of the dough sheet through the cutter-picker. In other implementations, the lip 315 can have alternative geometries. For instance, the outer cup 305 may be of uniform depth with a straight, or flat, lip 315. In the example of FIGS. 3A-B, the inner hole cup 310 has a uniform depth and flat lip, and is adapted to cut the hole from the bagel dough piece. The inner hole cup can possess alternative dimensions, and can even be adapted to cut non-circular or decorative holes from the bagel dough piece center.

Upon exiting the cutter of the cutter-picker assembly 130, the sheet of cut dough pieces proceeds to a picker, or hole removing device. While FIG. 1, shows the cutter and picker embodied within the same enclosure 130, in other implementations, the cutter and picker devices of the cutter-picker can be housed in separate enclosures and connected by a sheeting conveyor.

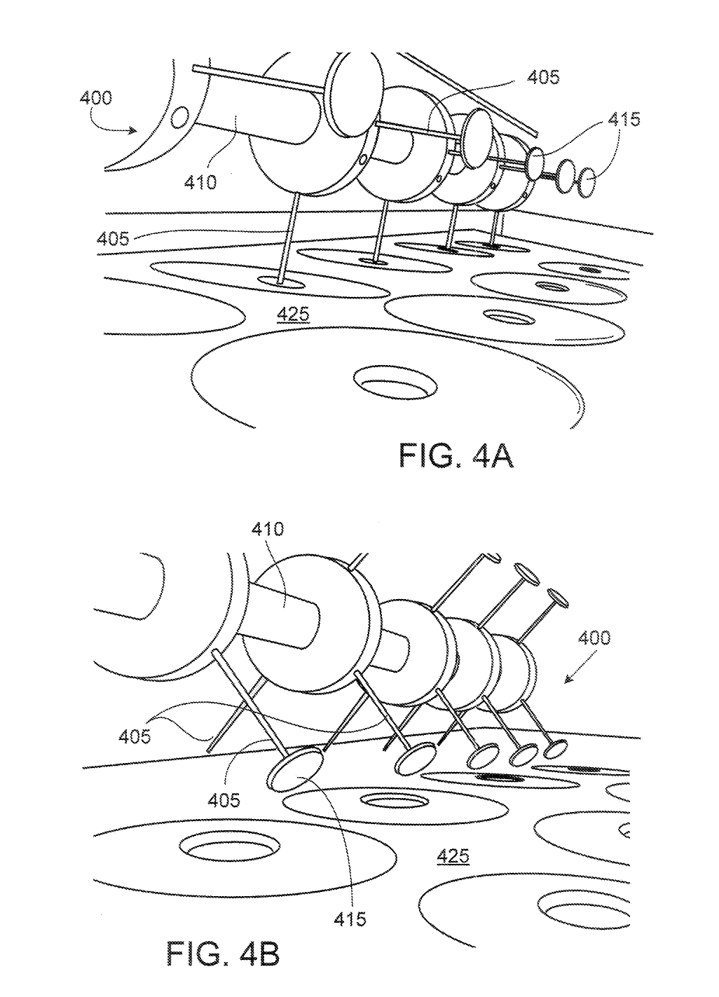

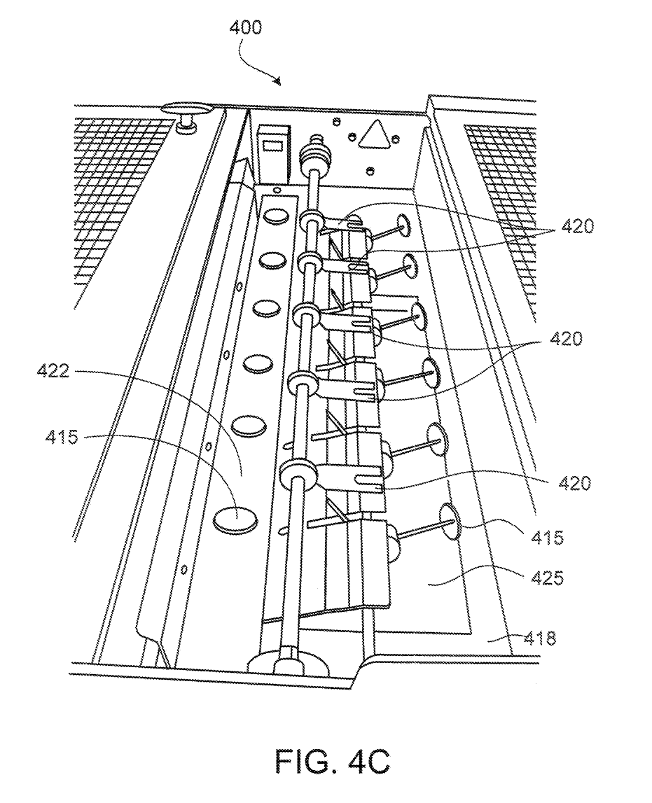

In one example, as shown in FIGS. 4A-4C, the picker 400 of the cutter-picker assembly includes barbed picks 405 positioned so as to correspond to the hole pieces cut by the cutter. The picks 405 extend from a rotary picker axis 410 that rotates at a velocity chosen to correlate with the speed of the dough sheet arriving at the picker 400. In this example, the rotation of the picker 400 is timed so that the picks 405 rotate to meet and spear the cut dough holes 415 (as shown in FIGS. 4A) as the cut dough sheet 425 proceeds along a conveyor 418. The picks 405 then lift and remove the dough holes 415 from the sheet (FIG. 4B) and transport the dough holes to a set of paddles 420 that rotate to meet the picks 405 and remove the dough holes from the pick's end (FIG. 4C). The paddles 420 can then flip or pass the dough holes 415 onto a scrap removal conveyor 422, either for disposal, separate processing, or recycling in a remix.

Other tools can be used in connection with, or in lieu of, the picker tool 400 illustrated in FIGS. 4A-4C. For instance, an air manifold can be used in connection with the picker tool described in connection with FIGS. 4A-4C. The air manifold can blow air up from beneath the conveyor as the dough sheet travels through the picker 400 to help promote removal of the holes 415 from the dough sheet 425. The use of air in the cutter-picker can also be advantageous at the cutter step, in that the air can be blown out from inside the die at the point of cutting so that the dough does not stick to the die during cutting. In an alternative picker design, a vacuum, such as a set of targeted vacuum tubes, can be employed, in lieu of picks and paddles, to catch and remove dough holes from the dough sheet, prior to the dough sheet being processed further.

In yet another example of an alternative picker tool, a set of diverging conveyors can be employed to remove scrap dough holes from the dough sheet by using timed air blasts or mechanical strippers to blow or push dough hole pieces down, through the dough sheet, onto a lower conveyor away from the remaining dough sheet, including the cut rings, diverted up toward, and proceeding onward on, an upper conveyor for additional processing. The scrap dough holes can then proceed on the lower conveyor for disposal or recycling.

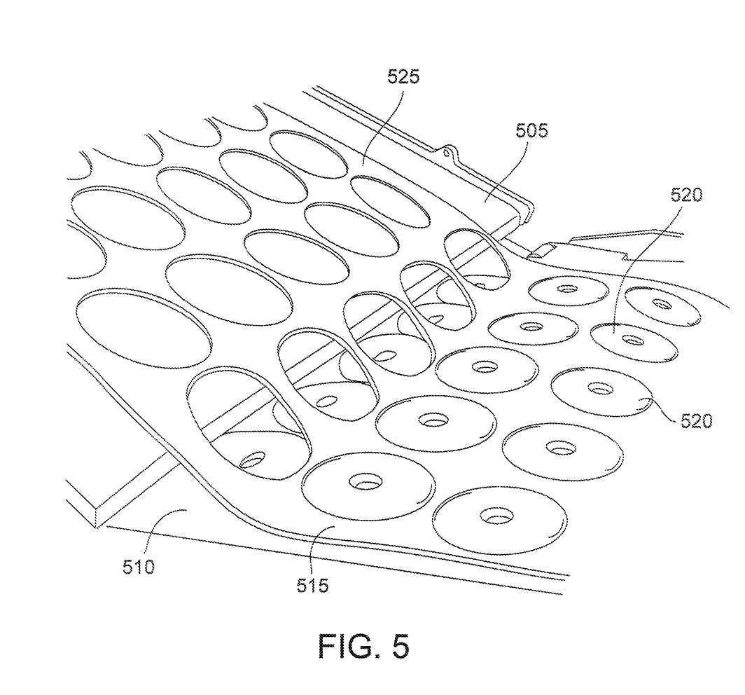

Once the dough sheet has been cut, and the bagel hole pieces removed, the cut dough sheet proceeds further to remove additional scrap from the sheet, so that only the dough ring pieces remain to be conveyed for further processing. In one example, a specialized sheeting table, similar to that illustrated in FIG. 5, can be used to separate the bagel ring dough pieces from the remaining sheet. In the example of FIG. 5, a set of two diverging conveyors 505, 510 can be employed. For each batch of dough to be processed, the leading edge of the dough sheet 515 can be diverted to the upper conveyor 505 to be led away from the bagel ring pieces 520. The resulting scrap dough sheet 525 can then be fed, from the upper conveyor 505, to a discharge conveyor 530 for disposal or remixing of the scrap 525. Meanwhile, the dough ring pieces 520, now removed from the sheet 515, can proceed along the lower conveyor 510 for further processing. The sheeting table 500 illustrated in FIG. 5, is but one example technique for removing excess dough and isolating the ring pieces 520 for further processing, and alternative techniques, machines, and orientations can be employed to achieve this result.

With the ring pieces formed and isolated, they are ready for further processing. As shown in FIG. 1, in one example, isolated ring pieces can be further transported along conveyors 160, 170, 180 for further processing, such as to a proofing sheet 190 for delivery to a proofer adapted to ferment, or proof dough. Additional processing steps in producing bagels from the ring pieces can include proofing, topping the bagels, cooking, and baking the bagels. After baking the bagels, still further steps can be incorporated to ready the product for consumers including cooling the product, slicing the finished bagels, sorting, and packaging the bagels.

Proofing is an important step in yeast-based bread products. Proofing refers to the process of allowing the dough to ferment and rise. Cut ring pieces can be fed, via a sheeting table and/or proofing board, into a proofing enclosure. The proofing enclosure is temperature-controlled so the bagels rise to the desired amount. The toriodal-shaped bagel dough portions can be proofed as is known in the art. The dimensions and ingredients used in the bagels can influence the proofing time and temperature needed. The proofing enclosure can further include controls for controlling proofing time and temperature, allowing for the production of various bagel sizes and types using the same enclosure. The proofing enclosure can be made of stainless steel, or other material. After proofing, the bagels may continue fermentation by storing in a refrigerated storing area.

After proofing, the fermented ring pieces can be transferred to a conveyor and may be topped with seeds, salts, or flavored food ingredients as is known in the art. It may be advantageous to wet a surface of the bagel, prior to or after topping, to enhance sticking of seeds and other toppings. Topping adhesion can be further enhanced by pressing the topping into the dough after it has been added. For instance, after the roller or rollers have made the dough sheet flat and of a desired thickness, and the dough has been wetted, for example, by a mist, topping is added, and then the topping is pressed into the dough, for example with another roller. Additionally, in some instances, it may be advantageous to top the ring pieces prior to proofing.

As is typical in traditional bagel preparation, the proofed ring pieces can be boiled briefly, prior to baking, in order to achieve the thick, chewy crust and shine characteristic of bagels. Steaming can be used in lieu of boiling the dough and is generally preferred for an automated bagel production process. If steaming is used alone, generally the steaming process takes several minutes to fully cook the ring pieces. The ring pieces may be steamed and then baked. In one example implementation, the bagels are steamed and baked concurrently in an oven. In another implementation, the ring pieces are boiled or steamed for a period of time less than is necessary to fully cook the ring pieces, for example between about 30-50 seconds, and then the resulting, partially-cooked ring pieces are baked in an oven with or without steam.

After boiling or steaming, the ring pieces are then preferably baked to time, temperature and color. In alternative implantations, the baking may even be completed alone, in lieu of steaming. Preservatives and glaze may be sprayed on the outside of the bagel prior to discharging the bagel products from the oven or alternatively at the oven discharge, which can provide an effective coating of preservative on the outside of the bagel product.

After cooking and baking the ring pieces, the ring pieces can be cooled to near ambient temperature. The product may also be dried as necessary. In one particular implementation, a spiral cooler, as known in the art, can be employed to cool and/or dry the product. Upon cooling and drying the product, the finished bagels can proceed through additional assembly steps such as slicing and packaging. Some of the steps described above have been employed in the manufacture of yeast, raised doughnuts. Given the high viscosity, elasticity, and dough memory of traditional bagel dough, the rolling, stamp cutting, and picking steps described above are typically inappropriate for commercial bagel production. Unlike doughnut dough, which has higher fat content and uses doughnut flour with lower protein content, bagel dough has relatively high viscosity, elasticity, and dough memory. As a consequence, bagel dough is relatively difficult to flatten, manipulate and form. For instance, referring back to FIG. 1., traditional bagel dough may not retain the desired shape and thickness following processing by the roller assembly 112. For instance, following the rolling step, the bagel dough may “spring back,” at least partially. This can cause the width of the bagel dough sheet to retract at the edges and develop a non-uniform perimeter, thicken, or develop non-uniform thickness. Such conditions are not ideal and can lead to poor weight control, misshapen and otherwise defective bagel products, leading to lower production yield. For instance, as the dough sheet is fed from the roller assembly 112 to a cutter-picker assembly 130, a retracting dough sheet may fail to line up correctly with the cutter-picker dies and result in deformed and irregular-cut ring pieces. Additionally, the failure of the bagel dough sheet to keep its shape and uniform thickness can result in cut bagel dough pieces of irregular and inconsistent thickness, mass, and shape. Consequently, in some implementations, it may be desirable to use an improved bagel dough formula adapted for use with a bagel production assembly that employs rolling, sheeting, and cutting steps similar to those illustrated and described in connection with FIGS. 1-5.

As shown in Table 1, traditional bagel dough is generally comprised of a mixture of flour, water, yeast, salt, sugar and other additives. The flour typically makes up 55-60% of the overall weight and should be high gluten, high protein, or “hard,” flour, such as good clear spring wheat flour with protein content of typically 11-16% of flour weight. Preferably, the protein content of bagel flour should include protein content between 13-14% of flour weight. Bagel flours and mixes also tend to have higher wheat gluten content. High protein, high gluten flour is generally preferred in bagels, because gluten protein facilitates conditioning and strengthening of the dough “sponge,” permitting the characteristic chewy crust and texture of finished bagels. This is due in part to the increased ability of high protein flours to absorb and retain water, when mixed in a dough. In traditional bagel dough, water is typically added in a quantity of typically 25-35% of total weight. Water can act as a plasticizer, a leavening agent, or both. When water acts as a plasticizer, water provides the dough composition with extensibility. Salt content should typically be less than 1.0% of total weight. Yeast should be added in a quantity of typically 1.0-1.5% of total weight. Sugar, which serves as a food for the yeast and less as a contributor to the final product, should be a dextrose, corn syrup, high fructose or other fermentable sugar, and can be added up to 5% of total weight. Residual sugar contributes to the browning of the crust during baking

TABLE 1
Traditional Bagel Dough Recipe

| INGREDIENTS | % Total Weight |
|---|---|
| Flour (100% Hard Wheat Bread Flour) | 55-65% |
| Sugar | 5% |
| Shortening | 0% |
| Non-fat dry milk | 0% |
| Salt | 1% |
| Yeast | 1-1.5% |
| Conditioners and preservatives | 1.5% |
| Water | 25-35% |
| Gluten | 1% |

On the other hand, as shown in Table 2, the composition of traditional yeast doughnut dough differs meaningfully from traditional bagel dough. One of the most obvious distinctions is the presence of fats, such as shortening, oil, lard, and butter, in doughnut dough. Typically, fats make up 4-6% of the total weight of yeast doughnut dough. Fat content in doughnut dough contributes both to the lower viscosity, lower elasticity, and higher caloric profile of yeast doughnut dough, as compared to the typical bagel dough recipe. Further, yeast doughnuts typically include a less protein-rich (or “softer”) flour, than is used in bagels. Typical yeast doughnut flour includes a blend of up to 75% hard wheat flour (having a protein content of 11-14% of flour weight), the remainder being soft wheat flour (having a protein content of 9-11% flour weight). Additionally, yeast doughnuts typically have no wheat gluten added to the dough, beyond gluten inherent in the doughnut flour, because additional vital wheat gluten significantly increases the viscosity and toughness of the doughnut dough and finished doughnut products, thereby vitiating the distinguishing characteristics of traditional doughnuts. Together, the use of fats and softer flour in yeast doughnuts contribute to its characteristically light and delicate texture. The differences in composition between typical yeast doughnut dough and bagel dough are deliberate and significant and are responsible for the overall difference in the character of both products. Flour

TABLE 2
Traditional Yeast Doughnut Dough Recipe

| INGREDIENTS | % Total Weight |
|---|---|
| Flour (75% Hard Wheat Bread Flour & | 48-58% |
| 25% Soft Wheat Pastry Flour) | |
| Sugar | 5% |
| Shortening | 6% |
| Non-fat dry milk | 1% |
| Salt | 1% |
| Eggs (optional) | 2% |
| Yeast | 2% |
| Water | 25-35% |

An improved bagel dough has been developed capable of being sheeted and rolled into a layer of substantially uniform thickness for use in bagel production assemblies similar to that illustrated in FIG. 1, while still possessing the necessary characteristics to produce a finished bagel with the characteristic chewy texture and consistency and caloric profile of traditional bagels. As shown in Table 3, an improved bagel dough can possess a higher water-to-flour ratio than traditional bagels, with flour content between 45-55% of total weight and water between 35-45% of total weight. Hard flour is used, with protein content 11-14% of flour weight. Despite the lower flour content, the improved formula includes higher wheat gluten content than is typical, with gluten content no less than around 1.5% of total weight of the dough. Yeast is also increased to between 2-3% total weight. Additionally, to enhance the texture of the bagel dough, fiber is added to make up 4-7% of total weight to enhance water absorption in the dough. The additional fiber content in the improved bagel dough can serve to increase the total amount of water remaining in the bagel after it is baked and cooled and help to produce a product with a reduced overall calorie content. By way of example, Table 4 shows one particular formulation of an improved bagel dough.

TABLE 3
Improved Bagel Dough Recipe

| INGREDIENTS | % Total Weight |
|---|---|
| Flour (100% Hard Wheat Bread Flour) | 40-55% |
| Sugar | 4-4.5% |
| Shortening | 0% |
| Non-fat dry milk | 0% |
| Salt | 1% |
| Yeast | 1-3% |
| Conditioners and preservatives | 1-1.5% |
| Water | 35-45% |
| Gluten | 1-3% |
| Fiber | 4-8% |

Generally, the high water-to-flour content of the improved bagel dough formula permits the improved dough to exhibit lower elastoviscosity and dough memory than traditional bagel dough, allowing the improved dough to be rolled and sheeted to a substantially uniform thickness without meaningful retraction. Additionally, the high protein, gluten, yeast, and fiber content of the improved formula permit the resulting bagel dough to be proofed, cooked, and baked into a bagel product exhibiting the characteristic texture, consistency, and taste of traditional bagels. In other words, the improved dough exhibits the easy formability of doughnut dough, while serving as the basis for producing a baked product possessing the taste, texture, and nutritional characteristics of traditional bagels.

TABLE4
Example Composition of Improved Bagel Dough Recipe

| INGREDIENTS | % Total Weight |
|---|---|
| Flour (100% Hard Wheat Bread Flour) | 49% |
| Sugar | 4.2% |
| Shortening | 0% |
| Non-fat dry milk | 0% |
| Salt | 1% |
| Yeast | 2.3% |
| Conditioners and preservatives | 1.3% |
| Water | 35% |
| Gluten | 1.5% |
| Fiber | 5.7% |

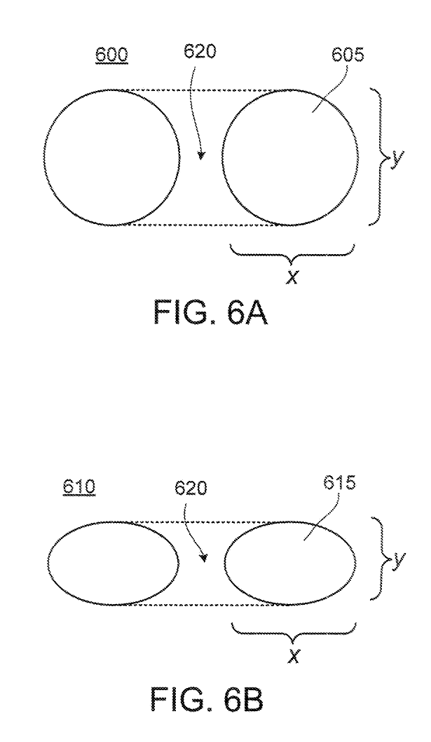

Considering traditional bagel dough's high elastoviscosity, the toroidal geometry of traditional finished bagels has typically been uniform. That is, the cross section 605 (or toroidal surface of revolution) of a traditional finished bagel 600, as illustrated in FIG. 6A, is typically substantially circular in dimension. However, using the improved dough, as described, for example, in connection with Tables 3 and 4 above, the height (or thickness) y of the bagel toroid can be adjusted, such as shown in FIG. 6B, to produce “thin” bagels 610, or bagels with a cross-section surface of revolution 615 that is substantially ovular, with a larger x dimension than y dimension, but a hole 620 with proportions similar to those found in typical bagels. They dimension of the thin toroidal-shaped bagel dough pieces can be “flattened” by producing the bagel using a technique similar to that described in connection with FIG. 1, including rolling the bagel dough sheet to produce a relatively thin sheet of dough for cutting by the cutter-picker. Typical bagels vary in dimension, but in one instance, a typical bagel with a diameter of between 4.0 and 4.5 inches will have a thickness (y) between 1.5 and 1.75 inches and hole 620 with a diameter between 0.75 and 1.0 inches. The width x of the cross-section 605 of a typical bagel approximates the thickness y. Using the process described above, including an improved recipe similar to that disclosed in connection with Tables 3 and 4, a thin bagel can be realized with a comparable overall diameter of 4.0 to 4.5 inches and hole diameter between 0.75 and 1.0 inches, but a thickness between 0.6 and 1.2 inches. In one example, a finished thin bagel with a diameter of four inches and thickness between 0.6 and 1.2 inches can be produced by flattening a dough sheet, of the improved recipe disclosed in connection with Tables 3 and 4, to a thickness between 0.2 and 0.4 inches. Alternatively, if a more traditional bagel thickness is desired using the improved bagel dough formula, the dough sheet can be flattened to between 0.5 and 0.8 inches.

A thinner bagel may be preferred by some customers who desire to have a lower bread-to-topping (e.g., cream cheese, deli meat slices, etc.) ratio or consumers desiring lower calorie bagels that still retain the taste and diameter of regular-sized bagels. In some instances, the proportions of the cross-section surface 615 of a finished thin bagel 610 can be set so that the x dimension (or width) of the cross-section 615 is between 1.6 and 3.2 times the thickness (y) of the bagel.

Bagel dough, including the improved bagel dough described above, can include additional ingredients, such as salt, sugar, and other ingredients. Salt can enhance the flavor of a baked product prepared from a dough composition of the invention, impart toughness to the gluten, and provide strength to the crumb. Salt can be present in an amount effective to provide a desirable flavor. Salts are typically present in a range of between about 0.3 weight percent and about 3 weight percent but may be present in a range from 0-5%. Sugar can also enhance the flavor of a baked product prepared from a dough composition of the invention. Sugar acts as a substrate for yeast and as a starting material for the Maillard reaction, which facilitates color formation of the crust. Sugar is typically present in a range of between about 1 weight percent and about 6 weight percent of the total dough composition but may be present in a range from 0-20%. Suitable sugars include granulated sugar, regular and high fructose corn syrup, sucrose (cane or beet sugar), dextrose, honey, etc.

Other bagel dough agents, capable of affecting the consistency and texture of the prepared bagel, can include, for example, ascorbic acid, and aging agent/blowing agents such as azodicarbonamide, etc., to strengthen the dough. Additives such as emulsifiers, dough-developing agents, nutritional supplements, flavorings, shelf-life stabilizers, thickeners, organic acids, oxidizers, and the like can likewise be added. Nutritional supplements can include vitamins, minerals, proteins, and the like, such as thiamin, riboflavin, niacin, iron, calcium, etc. Flavorings can include, by way of example, sweeteners, spices, and specific natural and artificial flavorings. Shelf-life stabilizers such as, for example, preservatives and mold inhibitors can also be added, such as sodium salts of propionic or sorbic acids, sodium diacetate, monocalcium phosphate, lactic acid, stearoyl lactylate, ascorbic acid, and the like, or combinations thereof. Exemplary suitable protein supplements can include proteins resulting from amino acids such as, for example glycine, alanine, leucine, isoleucine, valine, phentolanine, turicine, tryptophan, proline, methionine, cystine, serine, threonine, asparagine, glutamine, histidine, aspartic acid, glutamic acid, lysine, arginine, or combinations or mixtures thereof. Other suitable protein supplements include, for example, a-keratin, collagen, fibroin, sclerolin, myosin, actin, carboxypeptidase, trypsin, ovalbumin, casein, and the like.

Although it is possible to obtain and mix all the separate individual ingredients necessary for making bagel dough, a premixed powdered base can be used including many of the ingredients desired. Premixed powdered base can include a number of the additives to be added to the dough, including for example sugars, salt, reducing agents, oxidizing agents, blowing agents, Vital Wheat Gluten, preservatives, softeners, vitamin and mineral fortifiers, and/or other additives such as yeast, flavorants, specialty flours, and the like, and may further comprise a small portion of the flour to be added to the dough. A measurement of a premixed base can be mixed with warm water (e.g., 50-55. degree. F.), whereupon additional yeast and high gluten, hard flour can be added.

All ingredients for the bagel dough can be combined together in a mixer as is commonly used in the art. Extensibility and elasticity can be further specialized through the mix time employed. Generally, when mixed, the ingredients produce a stiff, highly viscous bagel dough. Once the dough composition has been prepared, it is fed to the sheeting table for processing (such as through the hopper 105 of the example implementation illustrated in FIG. 1).

A number of embodiments of the invention have been described. Nevertheless, it will be understood that various modifications may be made without departing from the spirit and scope of the invention. Accordingly, other embodiments are within the scope of the following claims.

What is claimed is:

1. A method for making a bagel comprising the steps of:
sheeting mixed bagel dough, using dough sheeting equipment, the bagel dough comprising, per 100 parts of total weight:
between 45 and 60 parts hard wheat flour, wherein hard wheat flour is at least 11% protein by weight;
between 25 and 45 parts water;
flattening the bagel dough, using at least one roller, into a sheet with a thickness between about 0.2 and 0.8 inches;
feeding the flattened bagel dough sheet to a cutter-picker assembly comprising an automated cutter and an automated hole removal tool;
cutting the bagel dough sheet into a plurality of substantially toroidal-shaped bagel dough pieces using the automated cutter, each toroidal-shaped bagel dough piece including a ring piece and a hole piece;
removing the bagel hole pieces from each of the plurality of toroidal-shaped bagel dough pieces with the automated hole remover tool;
further processing the ring piece by fermenting, water-cooking, and baking the ring piece.

2. The method of claim 1, wherein
the ring piece is fermented in a proofer;
the fermented ring piece is cooked in water; and
the water-cooked ring piece is baked in an oven.

3. The method of claim 1, wherein the bagel dough is flattened into a sheet with a substantially uniform thickness between 0.2 inches and 0.4 inches to produce a finished bagel with a thickness between 0.4 and 1.0 inches and a substantially ovular toroidal surface of rotation.

4. The method of claim 3, wherein the bagel dough comprises, per 100 parts of total weight:
between 45 and 55 parts hard wheat flour;
between 35 and 40 parts water; and
between 4 and 8 parts fiber.

5. The method of claim 4, wherein the bagel dough further comprises, per 100 parts of total weight, at least 1.5 parts gluten.

6. The method of claim 1, wherein the bagel dough is flattened into a sheet with a uniform thickness between 0.5 inches and 0.8 inches to produce a finished bagel with a thickness greater than 1.5 inches.

7. The method of claim 1, wherein water-cooking the bagel dough pieces comprises steaming the bagel dough pieces.

8. The method of claim 1, wherein the cutter is at least one of a rotary die cutter or flat bed die cutter.

9. The method of claim 1, further comprising topping uncooked bagel dough pieces with a topping ingredient.

10. The method of claim 1, wherein the automated bagel hole remover comprises:
a plurality of picks mounted on a rotary axle, each pick adapted to spear a hole piece and separate it from a corresponding ring piece according to a timed interval; and
a paddle adapted to contact the hole piece on at least one corresponding pick of the plurality of picks and remove the contacted hole piece from the at least one corresponding pick and divert the hole piece away from the ring piece.

11. The method of claim 1, wherein cutting the bagel dough sheet includes using an automated cutter having a plurality of die cutters, each die adapted to cut the bagel dough sheet into substantially toroidal-shaped bagel dough pieces.

12. The method of claim 11, wherein the each die cutter in the plurality of die cutters includes an outer blade cup and an inner blade cup, the inner blade cup positioned within and coaxial with the outer blade cup, wherein at least one of the outer blade cup and inner blade cup has an ovular shape.

13. The method of claim 12, wherein the ovular shaped blade cup is configured to produce a bagel dough piece that, after subsequent transportation, cooking, and baking, produces a substantially circular finished bagel.

14. A bagel dough food product, adapted for sheeting on a bagel production assembly to produce a bagel dough sheet with uniform thickness between 0.2 and 0.4 inches, the bagel dough comprising, per 100 parts of total weight:
between 40 and 55 parts hard wheat flour, wherein hard wheat flour is at least 11% protein by weight;
between 35 and 45 parts water;
between 1 and 3 parts yeast;
between 1 and 3 parts gluten; and
between 4 and 8 parts fiber.

15. The bagel dough food product of claim 14, wherein the hard wheat flour has at least 13.5% protein by weight.

16. The bagel dough food product of claim 14, wherein the bagel dough has substantially no fat content.

17. The bagel dough food product of claim 14, when formed into a toroidal, bagel shape, cooked in water, and baked, forms a bagel.

18. The bagel dough food product of claim 14, wherein the bagel dough sheet is further processed to produce a finished bagel food product by:
cutting a plurality of toroidal shaped bagel dough pieces from the sheet using an automated cutter having a plurality of dies to form a plurality of bagel dough ring pieces and bagel dough hole pieces;
removing the hole pieces using an automated hole removal picker;
fermenting the ring pieces in a proofer;
water-cooking the fermented ring pieces; and
baking the water-cooked ring pieces in an oven.

19. The bagel dough food product of claim 18, wherein the finished bagel food product is substantially toroidal and has a two-dimensional cross-section surface of rotation with a width (x) between 1.6 and 3.2 times the thickness (y) of the cross-section surface.

20. The bagel dough food product of claim 18, wherein the finished bagel food product has an outer diameter between 4.0 and 4.5 inches, a hole with a diameter between 0.75 and 1.0 inches, and a thickness (y) between 0.6 and 0.9 inches.

21. The bagel dough food product of claim 18, wherein water-cooking the fermented ring pieces includes steaming the fermented ring pieces.

22. A bagel production apparatus comprising:
a sheeting table to which a bagel dough is supplied;
at least one roller adapted to flatten the dough to a dough sheet having a thickness between about 0.2 and 0.8 inches;
an automated cutter plate adapted to cut the bagel dough sheet into a plurality of substantially toroidal-shaped bagel dough pieces using the cutter, each toroidal-shaped bagel dough piece including a ring piece and a hole piece;
an automated hole picker device, adapted to remove the hole piece from the ring piece;
a bagel dough proofer;
a water cooking apparatus for partially cooking proofed ring dough pieces; and
an oven for baking partially-cooked ring dough pieces.

23. The apparatus of claim 22, wherein:
the cutter plate is a rotary die cutter including a plurality of dies, each die adapted to cut toroidal-shaped bagel dough pieces from the dough sheet; and
the hole picker device includes:
a plurality of picks, each pick adapted to spear and remove bagel hole dough pieces from the ring dough piece, wherein the plurality of picks are attached to a rotating axle timed to cause the end of at least one of the picks to spear a hole dough piece as the hole dough piece is conveyed on a sheeting table; and
a plurality of paddles, each paddle adapted to contact at least one of the hole pieces on at least one of the picks and remove the speared hole dough piece from the pick.

24. The apparatus of claim 22, wherein the water cooking apparatus is a steamer.
